(19) United States
(12) Patent Application Publication
(10) Pub. No.: US 2009/0155007 A1
(43) Pub. Date: Jun. 18, 2009

(54) Abrasive coated bit

(75) Inventor: Jie Liu, Lisle, IL (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignees: Credo Technology Corporation, Broadview, IL (US); Robert Bosch GmbH, Stuttgart (DE)

(21) Appl. No.: 12/002,436

(22) Filed: Dec. 17, 2007

(51) Int. Cl. B23B 51/08; B23B 35/00

(52) U.S. Cl. 408/22; 408/1 R

(57) ABSTRACT

A rotary tool accessory and method for shaping hard, brittle material is disclosed. In one embodiment a rotary tool accessory for cutting hard, brittle material, includes a shaft for coupling with a rotary tool, a work portion extending outwardly from the longitudinal axis of the shaft, the work portion including a cylindrical portion and a spherical portion, a nickel based bonding material affixed to the work portion, and a plurality of abrasive particles extending outwardly of the bonding material.

### FIELD OF THE INVENTION

This invention relates to the field of rotary tool bits and more particularly to bits for hand-held rotary tools.

### BACKGROUND

Hand-held rotary tools are widely used by many people, including drywallers, professional remodelers, tile installers, homeowners, and artists. These rotary tools typically include an outer housing designed to be easily held within a human hand. The housing retains an electric motor which is operable to drive a rotatable collet or chuck of the rotary tool. An accessory may be releasably coupled with the collet thereby enabling the rotary tool to rotatably drive the accessory.

The widespread use of Hand-held rotary tools is a result, in part, of the wide variety of accessories that may be used with the tools. The accessories include various cutting bits, cut-off wheels, polishing wheels, grinding wheels, and sanding discs. Cutting accessories may further be specifically designed for the particular type of material that is to be cut. For example, U.S. Pat. No. 6,758,639 assigned to Credo Technology Corporation discloses a bit that is designed for use with drywall.

To cut sheetrock or drywall, a spiral bit must be capable of first axially penetrating the drywall panel, and then making a lateral cut in the panel. The drywall bit can be used first to drill through the panel directly adjacent to an electrical outlet box, for instance. The bit is then conveyed in a direction perpendicular to the length of the bit, following the contour of the outlet box. The rotary tool is then manipulated to completely encircle the outlet box to cut the preferred opening in the drywall panel. In order to address these specific needs, the '639 patent discloses a bit with a single helical flute having a particular geometry. In one embodiment, the flute defines a cutting edge within a specific range of helix angles relative to the longitudinal axis of the bit. In another feature, the cutting edge of the flute is situated at a particular rake angle relative to the axis of the bit and the fluted portion of the bit has a web thickness that is based upon the cutting diameter of the bit.

In bits such as the bit disclosed in the '639 patent, cutting edges are defined by the junction of a flute and a land. The cutting edges penetrate the material being shaped and carve out a wedge of the material. While this mechanism is useful in relatively soft, ductile materials, it is not effective in harder and/or more brittle materials. For example, it is exceedingly difficult to cut through materials such as granite or hard crystalline material wherein the hardness of the material being cut approaches the hardness of the cutting bit. Likewise, it is difficult to achieve a cut efficiently and effectively when working with hard and brittle materials such as various types of tile and glass.

Typically, two types of drill bits, the spear point drill bit and the core drill bit, are utilized when cutting ceramics materials. The spear point drill is shaped much like a spear point. The core drill has a hollow core with a cylindrical cutting edge surrounding the core. These bits may be modified to include a diamond abrasive on the cutting edge of the bit. While these bits are useful in boring operations such as making a hole through a material, neither bit can be used to cut along a line in the plane of the material such as to provide cutout areas in a tile.

What is needed is a configuration for an accessory that reduces the problems associated with the cutting of hard or brittle materials such as floor and wall tile.

### SUMMARY

In accordance with one embodiment of the present invention, there is provided a rotary tool accessory for cutting hard, brittle material, includes a shaft for coupling with a rotary tool, a work portion extending outwardly from the longitudinal axis of the shaft, the work portion including a cylindrical portion and a spherical portion, a nickel based bonding material affixed to the work portion, and a plurality of abrasive particles extending outwardly of the bonding material.

In accordance with another embodiment of the present invention, there is provided a method of drilling a hole in a hard surface. This method includes, spin the accessory at the desired RPM, contact the hard surface with the spherical tip of the rotating accessory to initiate a bore, and rotate the rotary tool in a conical with axis of the tool inclined an angle of at least 15° from the surface normal and with the accessory pivoting at the spherical tip. Keep rotating the tool in this manner until the accessory drill through the material.

In accordance with another embodiment of the present invention, there is provided a method of making cut-outs in a hard material. This method includes, spin the accessory at the desired RPM, keep cylindrical portion of the accessory in contact of the material being cut, reciprocate the bit along the accessory axial direction, and push the accessory along the direction normal to the axis of the accessory to remove material. Keep moving tool in this manner to make cut-outs of any shape and size.

In yet another embodiment, a hand held rotary tool accessory for shaping hard, brittle material includes a rotary tool accessory for cutting hard, brittle material, comprising a steel shaft for coupling with a rotary tool, a work portion extending outwardly from the longitudinal axis of the shaft, the work portion including a first functional area and a second functional area, a nickel based bonding material affixed to the first functional area and the second functional area, a plurality of abrasive particles extruding outwardly of the bonding material on the first functional area and the second functional area.

### BRIEF DESCRIPTION OF THE DRAWINGS

FIG. 1 shows a partial perspective view of a hand-held rotary tool coupled with a bit including a spherical tip and a cylindrical portion in accordance with principles of the present invention;

FIG. 2 shows a plan view of the bit of FIG. 1;

FIG. 3 shows a cross-sectional view of the bit of FIG. 1;

FIG. 4 shows a partial cross-sectional view of the cylindrical portion of the bit of FIG. 1 with generally between about 30 percent and 50 percent of each of the abrasive particles extending outwardly from the bonding material of the bit in accordance with principles of the present invention;

FIG. 5 shows a cross-sectional view of a work piece with the rotary tool and the bit of FIG. 1 positioned about 15 degrees off of an axis that is perpendicular to the work piece at a target point of the work piece in accordance with principles of the present invention;

FIG. 6 shows a cross-sectional view of the work piece of FIG. 5 with the rotary tool and the bit of FIG. 1 after a bore has been made into the work piece at the target point of the work piece; and

FIG. 7 shows a work piece with the rotary tool and the bit of FIG. 1 in the process of making a circular cut-out using a reciprocating motion in accordance with principles of the present invention.

### DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

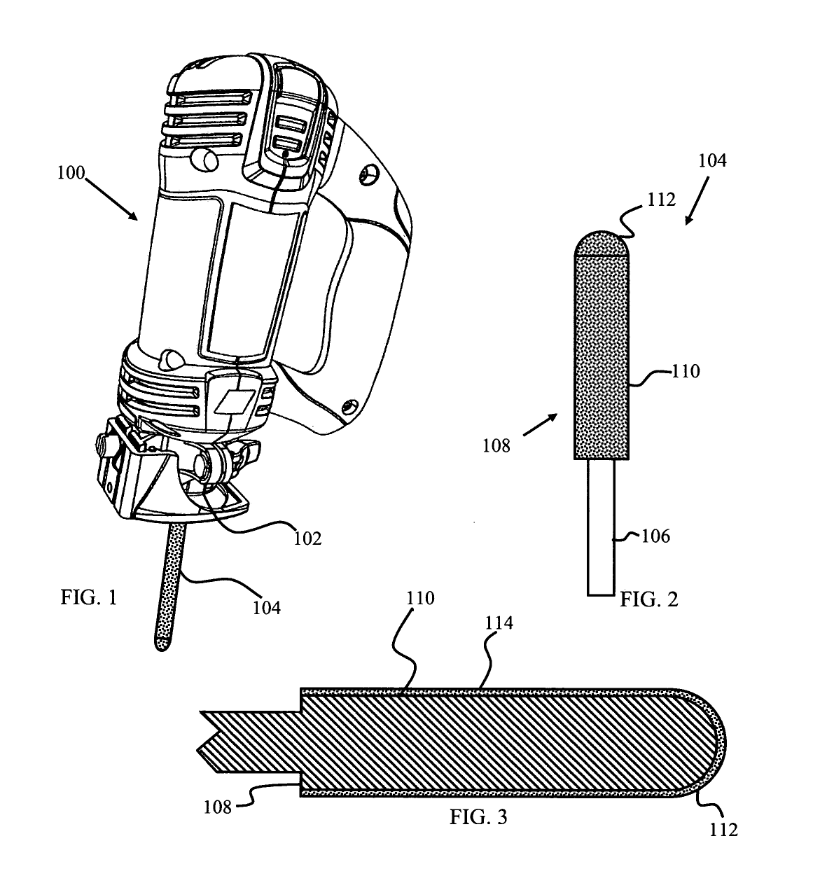

FIG. 1 shows a perspective view of a hand-held rotary tool 100. The rotary tool 100 includes a motor (not shown) for providing rotational movement to a collet 102. A bit 104 is releasably coupled to the collet 102. Operation of the motor in the rotary tool 100 rotates the collet 102 which in turn rotates the bit 104.

As shown in FIG. 2, the bit 104 includes a shaft portion 106 that is configured to couple with the collet 102 of the rotary tool 100. The opposite end of the bit 104 is a work portion 108. The work portion 108 extends outwardly from the longitudinal axis of the shaft portion 106 and includes a functional area 110 and a functional area 112. The bit 104 is made of steel having an HRC hardness of about 50 to 55. In one embodiment, AISI 4140 steel is used to fabricate the bit 104. Using high hardness steel allows the diameter of the shank to be reduced to a smaller size. A softer material may be used if the shank is the same in diameter with the cylindrical portion without coating.

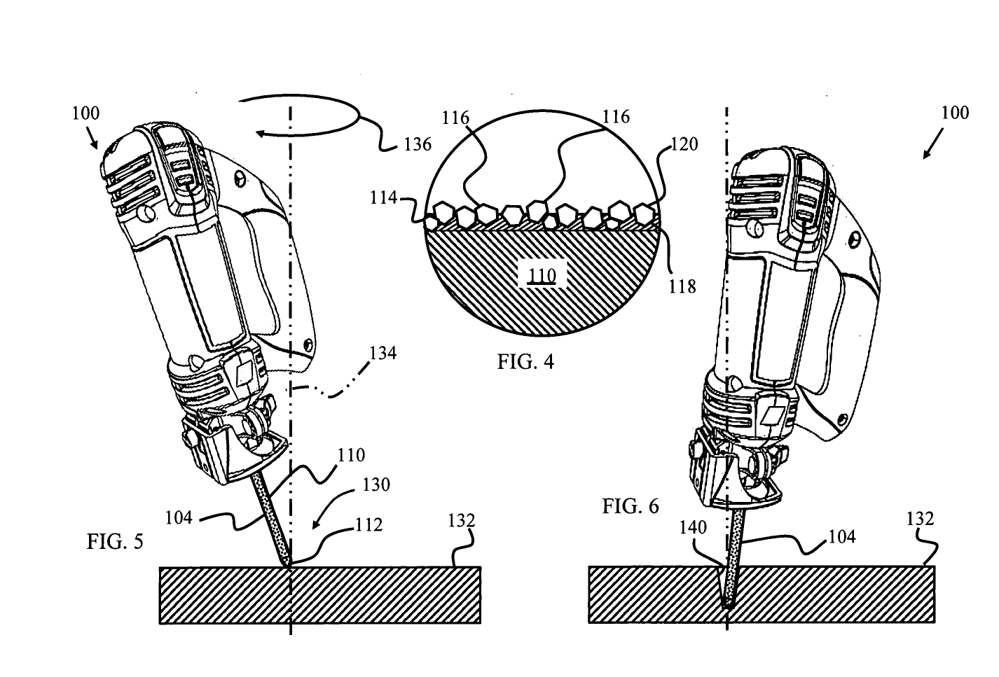

The functional area 110 and the functional area 112 are coated with a bonding material 114 which is shown more clearly in FIG. 3. Abrasive particles 116 are partially embedded within the bonding material 114 throughout the functional area 110 and the functional area 112 in an electroplating operation as shown in FIGS. 4 and 5. The abrasive particles 116 in this embodiment are diamond particles with grit selected from a range of about 20 to 120. In a further embodiment, particles with grit between about 30 and about 40 are used. This size abrasive is particularly well suited for making rough cuts in hard, brittle material when used on a high speed rotary tool.

The abrasive particles 116 located on the functional area 110 include an embedded portion 118 and an extruding portion 120. The amount of bonding material 114 that is applied to the functional area 110 is controlled to generate the desired binding strength. In this embodiment, the amount of bonding material 114 is controlled to generate a protrusion of between about 30 percent and 55 percent for the abrasive particles 116 located on the cylindrically shaped functional area 110. Thus, while some of the abrasive particles 116 may not be within the desired range, most of the abrasive particles 116 will exhibit an extruding portion 120 that is between about 30 percent and 55 percent of the respective abrasive particle 116.

In addition to controlling the amount of bonding material 114, the amount of abrasive particles 116 may be controlled to provide the desired coverage. In the embodiment of FIG. 4, the abrasive particles 116 are bonded to the bit 104 at a concentration that results in an average spacing between adjacent abrasive particles 116 of 100 percent or a “full concentration.” That is, the distance between adjacent abrasive particles 116 is roughly equal to the sum of the radii of the two abrasive particles 116.

Operation of the bit 104 is explained with reference to FIGS. 5, 6 and 7. Initially, the rotary tool 100 is coupled with the bit 104 and the bit 104 is positioned at a target area, generally identified by the reference number 130, of a work piece 132. In the event the axis of the bit 104 is aligned with the axis 134 which is perpendicular to the work piece 132 at the target area 130, the tip of the bit 104 would spin on the work piece 132. The constant contact would generate excessive heat at the tip of the functional area 112. Additionally, the speed of the bit 104 at the contact point with respect to the work piece 132 is at a minimum when the tip of the bit 104 is in contact with the work piece 132. Accordingly, in this example, the rotary tool 100 is pivoted as necessary to provide an angle between the axis of the bit 104 and an axis 134 of at least about 15 degrees.

The rotary tool 100, which may be energized either prior to contacting the target area 130 or after the bit 104 has contacted the target area 130, is then swiveled about the axis 134 in a circular motion as indicated by the arrow 136. The rotary tool 100 may be swiveled in a clockwise direction, a counter-clockwise direction or a combination. In this manner, the grits on the tip of the bit removes material from the target area 130. Accordingly, the swiveling of the rotary tool 100 about the functional area 112 of the bit 104 generates a bore 140 with sloped sidewalls as shown in FIG. 6.

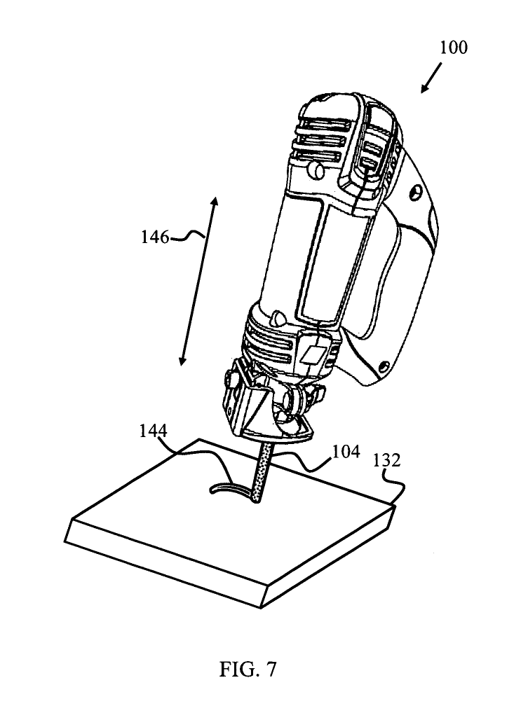

Alternatively, the bit 104 may be pivoted within a single plane thereby generating an elongated bore with two straight sides and two sloped end walls. Continued movement in a single direction, however, generates excessive heat. Accordingly, for linear cuts such as the cut 144 in FIG. 7, the bit 104 should be reciprocated along the axis of the bit in the work piece 132 as indicated by the double ended arrow 146.

The bore 140 at the upper portion of the work piece 132 is wider than the bit 104. Accordingly, dust and debris may exit the bore 140 as the bore 140 is being machined. Additionally, the gap between the bit 104 and the bore 140 allows coolant fluid, such as air or water, to cool the portion of the bit 104 that is not in contact with the work piece 132. Debris removal and/or cooling may be further enhanced by movement of the bit 104 inwardly and outwardly of the bore 140.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

1. A rotary tool accessory for cutting hard, brittle material, comprising:
a shaft for coupling with a rotary tool;
a work portion including a cylindrical portion and a spherical portion;
a nickel based bonding material affixed to the work portion; and
a plurality of abrasive particles extending outwardly of the bonding material.

2. The accessory of claim 1, wherein:
the plurality of abrasive particles comprises particles having a size of between about 20 and about 120 grit;
the extension of the plurality of abrasives on the cylindrical portion is generally between about 30 percent and about 55 percent.

3. The accessory of claim 2, wherein the plurality of abrasive particles comprise diamond particles.

4. The accessory of claim 3, wherein the plurality of abrasive particles are between about 30 and about 40 grit.

5. The accessory of claim 1, wherein the plurality of abrasive particles comprises diamond particles spaced to provide a full concentration.

6. A method of drilling a hole in a hard surface comprising:
positioning a spherical work portion of an accessory on a target area of the hard surface;
rotating the accessory with the rotary tool;
pivoting the rotating accessory to initiate a bore into the hard surface at the target area; and
swirling the tool with the bit in a conical shape to drill the hole.

7. The method of claim 6, wherein positioning a cylindrical work portion comprises positioning a cylindrical work portion with an abrasive particle extension generally between about 30 percent and about 55 percent.

8. A method of making cut-outs in a hard material comprising:
reciprocating the accessory along the axis direction of the bit in the hard material and push the tool in the desired direction to make cut-outs of any shape and any size.

9. The method of claim 6, wherein:
pivoting the rotating accessory comprises pivoting the rotating accessory to an angle of at least 15 degrees off of an axis extending perpendicularly to the hard surface from the target area; and
contacting the bore about the periphery of the bore comprises swiveling the rotary tool while maintaining the accessory at an angle of at least 15 degrees off of the axis.

10. A rotary tool accessory for cutting hard, brittle material, comprising:
a steel shaft for coupling with a rotary tool;
a work portion including a first functional area and a second functional area;
a nickel based bonding material affixed to the first functional area and the second functional area;
a plurality of abrasive particles extruding outwardly of the bonding material on the first functional area and the second functional area.

11. The accessory of claim 10, wherein:
the plurality of abrasive particles comprises particles having a size of between about 20 and about 120 grit; and
the extrusion of the plurality of abrasive particles is between about 30 percent to about 55 percent.

12. The accessory of claim 11, wherein:
the work portion is a steel work portion with a hardness of about HRC 50 to about HRC 55; and
the plurality of abrasive particles comprise diamond particles.

13. The accessory of claim 12, wherein the plurality of abrasive particles are between about 30 and about 40 grit.

14. The accessory of claim 10, wherein:
the first functional area is cylindrically shaped; and
the second functional area is spherically shaped.

15. The accessory of claim 10, wherein the plurality of abrasive particles comprise diamond particles providing a full concentration.
